(19) United States
(12) Patent Application Publication
(10) Pub. No.: US 2024/0021940 A1
(43) Pub. Date: Jan. 18, 2024

(54) MANIFOLD CASE AND THERMAL MANAGEMENT SYSTEM INCLUDING SUCH A MANIFOLD CASE

(71) Applicant: A. RAYMOND ET CIE, GRENOBLE CEDEX 1 (FR)

(72) Inventors: Jérôme CHAUPIN, ST PIERRE ALLEVARD (FR); Frédéric POGGI, FONTAINE (FR)

(21) Appl. No.: 18/350,467

(22) Filed: Jul. 11, 2023

(30) Foreign Application Priority Data
Jul. 12, 2022 (FR) 2207143

(51) Int. Cl. H01M 50/242; H01M 50/262; H01M 10/48; H01M 50/213; H01M 10/6568; F28F 9/06

(52) U.S. Cl. CPC H01M 50/242; H01M 50/262; H01M 10/488; H01M 50/213; H01M 10/6568; F28F 9/06

(57) ABSTRACT

A manifold case for a fluid for connecting to tubes, includes a manifold and a linking member having adapters, the manifold including a column provided according to a longitudinal axis with a plurality of connectors spaced apart from each other, each connector defines a passage for flow of the fluid provided with a free end which defines an orifice for flow of the fluid, the connectors and the adapters are capable of being received by each other, and the manifold case including a plurality of joint rings, each ring is disposed between one of the connectors and one of the adapters. The linking member includes: a first position, in which the adapters are capable of receiving tubes so that each tube passes through one of the rings the linking member, a second position, in which the joint rings are capable of being compressed.

### CROSS-REFERENCE TO RELATED APPLICATIONS

This application is based on and claims priority under 35 U.S.C. § 119 to French Patent Application No. FR2207143, filed on Jul. 12, 2022, in the French Intellectual Property Office, the disclosure of which is incorporated by reference herein in its entirety.

### BACKGROUND

### Field

The present disclosure relates to a manifold case for a fluid for connecting to tubes, in particular to tubes with micro-channels. The present disclosure also relates to a thermal management system including such a manifold case and a battery pack having such a manifold case.

### BRIEF DESCRIPTION OF RELATED DEVELOPMENTS

In particular, in the field of vehicles with electric and/or hybrid motorisation, the electric energy is provided by batteries that are heated during operation. It is indispensable to cool the batteries in order to avoid damage due to the too-high temperatures. Generally, the thermal regulation is ensured via a heat transfer fluid that circulates in a cooling system. Cooling systems including tubes and connectors that are used for this purpose are known from the prior art. Nevertheless, there are disadvantages in these systems, for example the tubes are rigidly connected to the connectors by brazing, or the assembly of the tubes and of the connectors appears to be laborious, or the structure is complicated to provide good and reliable sealing inside the connector.

The patent document FR 3081545 describes a battery-cooling device, the various elements of which (collector, cases and tubes) are rigidly connected to each other mechanically in order to avoid defects and brazing stresses. The disclosure also relates to a method for assembling a cooler, but the method comprises numerous steps and lacks efficiency for the assembly and mass production.

### SUMMARY

The present disclosure aims to overcome these disadvantages, by proposing a manifold case that allows to have a simplified mounting with a reduced assembly force and a simple structure while guaranteeing the required sealing, as well as the mechanical retention of the elements. The present disclosure also relates to the assembly of a manifold case and a tube. The present disclosure further relates to a thermal management system including at least one manifold case according to the present disclosure. The present disclosure also relates to a battery pack including at least one manifold case according to the present disclosure.

For this purpose, the present disclosure relates to a manifold case for a fluid for connecting to tubes.

The manifold case includes a manifold and a linking member having adapters, the manifold comprising a column provided according to a longitudinal axis with a plurality of connectors spaced apart from each other, each connector defines a passage for flow of the fluid provided with a free end which defines an orifice for flow of the fluid, the connectors and the adapters are capable of being received by each other, and the manifold case comprising a plurality of joint rings, each joint ring is disposed between one of the connectors and one of the adapters.

According to one aspect of the disclosure, the manifold case has the following features: the linking member comprises:
a first position, called assembly position, in which the adapters are capable of receiving tubes so that each tube passes through one of the joint rings,
a second position, called working position, in which the joint rings are capable of being compressed and/or deformed between the manifold 500A and the linking member.

Moreover, the linking member goes from the first position to the second position with a relative movement in translation between the manifold and the linking member.

Advantageously, the connector has a simple structure and provides good and reliable sealing.

Advantageously, the linking member ensures the function of indexing the tubes, of shaping and of guiding the tubes. This allows an assembly between the linking member and the manifold by a simple relative movement between these two elements.

Also advantageously, the linking member can be configured so as to have clipping between the linking member and the manifold.

In one aspect, in the second position, the manifold and the linking member cooperate so that the joint rings are sandwiched between the adapters and the connectors.

In one aspect, at least one joint ring is a sealing ring.

Advantageously, this allows to guarantee sealing.

In one aspect, the manifold case includes visual verification means allowing to verify the state of assembly between a manifold and a linking member.

Advantageously, this allows to ensure good assembly. In one aspect, the linking member is retained to the manifold in the first position and/or in the second position by mechanical fastening means.

Advantageously, this allows a simple assembly without need for a special tool or method.

In one aspect, the linking member is retained to the manifold in the first position and/or in the second position by a snap-on connection.

Advantageously, this allows to obtain a sensation of clipping during the assembly and a simple disassembly.

In one aspect, at least one joint ring comprises at least two retaining lips on its inner surface.

Advantageously, this allows to obtain better sealing and/or better mechanical gripping between the joint ring and the tube.

In one aspect, in the working position, a connector and a joint ring, forming a male interface, are received in an adapter that forms a female interface.

In one aspect, the connector and the joint ring are overmoulded.

Advantageously, this allows to keep the shape of the joint ring before introducing the tube, and thus to avoid it being damaged by the tube.

In one aspect, the female connector, the male interface characterised in that, in the working position, an adapter and a joint ring, forming a male interface, are received in a connector that forms a female interface.

In one aspect, the adapter and the joint ring are overmoulded.

Advantageously, this allows to keep the shape of the joint ring before introducing the tube, and thus to avoid it being damaged by the tube.

In one aspect, the linking member includes a plurality of pairs of adapters, each pair of adapters being linked by an intermediate zone.

According to a second aspect of the disclosure, the assembly of a manifold case according to the present disclosure and at least one tube received in the linking member.

In one aspect, the tube is a tube with micro-channels including at least one flat surface.

In one aspect, the tube is a tube with micro-channels including at least one corrugated surface.

Advantageously, all of the connector and the tube are capable of cooling or heating objects having a variety of surfaces.

According to a third aspect of the disclosure, the thermal management system including at least one manifold case according to the present disclosure.

According to a fourth aspect of the disclosure, the battery pack including at least one manifold case according to the present disclosure.

According to a fourth aspect of the disclosure, the present disclosure relates to a method for assembling a manifold case according to the present disclosure and the tubes. The method includes the following steps:
a). the linking member having adapters is positioned with respect to the tubes, so that each tube is received by one of the adapters and each tube passes through one of the joint rings;
b). a relative movement in translation between the manifold and the linking member is carried out, so that the connectors and the adapters are received by each other and the joint rings are compressed between the manifold and the linking member.

Advantageously, the assembly method is simple and effective.

In one aspect, the tubes are prepositioned.

In one aspect, the linking member is retained to the manifold by mechanical fastening means in step b).

### BRIEF DESCRIPTION OF THE DRAWINGS

Other advantages, goals and features of the present disclosure are clear from the following description given, for explanatory and in no way limiting purposes, with regard to the appended drawings, in which:

FIG. 1 shows a perspective view of a group of batteries, the thermal management tubes of which are rigidly connected to the connectors by brazing;

FIG. 2 shows an exploded view of a group of batteries, the thermal management tubes of which are connected by manifold cases according to a first aspect of the present disclosure;

FIG. 3 shows a cross-sectional view of a manifold case according to a first aspect of the present disclosure;

FIG. 4 shows a perspective view of a group of batteries, the thermal management tubes of which are connected by manifold cases according to a second aspect of the present disclosure;

FIG. 5 shows a perspective view of a manifold case according to a second aspect of the present disclosure;

FIG. 5A shows a perspective view of a manifold case connected to the tubes according to a second aspect of the present disclosure;

FIG. 6 shows a partial view of a manifold case according to a second aspect of the present disclosure;

FIG. 7 shows a cross-sectional view of a manifold case according to a second aspect of the present disclosure;

FIG. 8 shows a top view of a manifold case according to a second aspect of the present disclosure;

FIG. 9 shows an exploded view of a manifold case connected to the tubes according to a second aspect of the present disclosure;

FIG. 10 shows a perspective view of a group of batteries, the thermal management tubes of which are connected by manifold cases according to a second aspect of the present disclosure;

FIG. 11 shows a perspective view of a group of batteries, the thermal management tubes of which are connected by manifold cases
according to a second aspect of the present disclosure

FIG. 12 shows a perspective view of a group of batteries, the thermal management tubes of which are connected by manifold cases put in place in a module and/or battery pack according to a second aspect of the present disclosure;

FIG. 13 shows a partial cross-sectional view of a group of batteries of [FIG. 12].

### DETAILED DESCRIPTION

The various drawings as well as the elements of the same drawing are not necessarily shown on the same scale. In all of the drawings, the identical elements have the same numerical reference.

The terminology used in the present description must not in any case be interpreted in a limiting or restrictive manner, simply because it is used in conjunction with a detailed description of certain aspects of the disclosure.

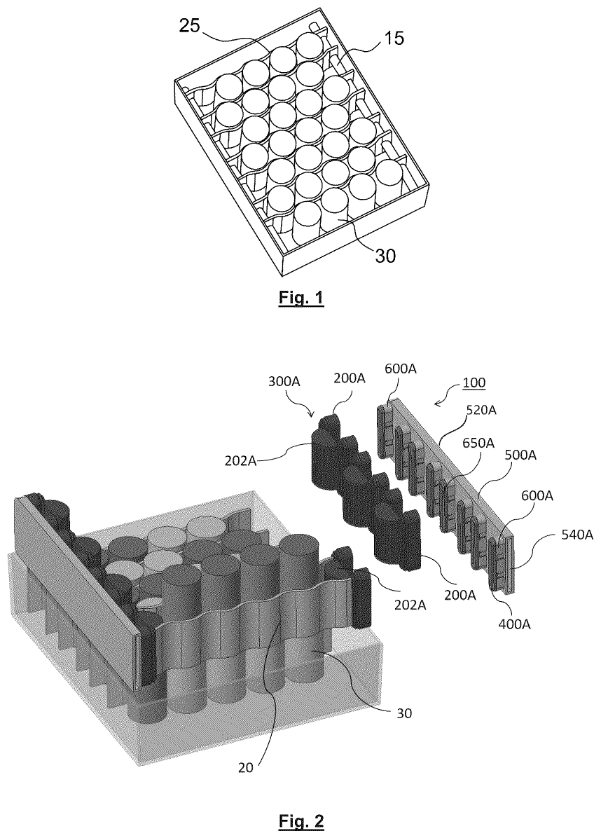

FIG. 1 shows a perspective view of a group of cylindrical cells 30, the thermal management tubes 25 of which are rigidly connected to the connectors 15 known from the prior art, for example, in the patent document US2021/0159567 or US2013/0196184. Indeed, the tubes and connectors are rigidly connected by brazing.

FIG. 2 shows an exploded view of a group of cylindrical cells, the thermal management tubes 20 of which are connected by manifold cases 100 according to a first aspect of the present disclosure.

This manifold case 100 is for example intended to be mounted on a network of pipes for circulation of a fluid of a battery pack. The fluid can be a heat transfer liquid. As shown, this network has a row of ends of tubing extending longitudinally to which the manifold case 100 can be mounted.

The manifold case 100 according to the present disclosure includes a manifold 500A and a linking member 300A. The manifold 500A comprises a column 520A provided according to a longitudinal axis with a plurality of connectors 600A spaced apart from each other. The linking member 300A includes adapters 200A. In this example, the adapters 200A are provided with openings capable of receiving connectors 600A.

According to the disclosure, each connector 600A defines a passage for flow of the fluid provided with a free end which defines an orifice for flow of the fluid 650A.

According to the disclosure, the manifold case 100 comprises a plurality of joint rings 400A to advantageously ensure the sealing. Indeed, each joint ring 400A is disposed between a connector 600A and an adapter 200A.

In this first aspect, the adapters 200A each include another opening and are capable of receiving tubes by this opening so that each tube passes through one of the joint rings 400A, when the connectors 600A are received in the adapters 200A.

In one aspect, the joint rings 400A are advantageously arranged so that they are not cut by the tubes 20 when they receive the latter.

The manifold 500A and the linking member 300A cooperate so that the joint rings are sandwiched between the adapters 200A and the connectors 600A. It is recalled here that the ramp is in a second position.

When the connector is in a second position, called working position, the joint rings 400A are capable of being compressed and/or deformed between the manifold 500A and the linking member 300A.

According to the disclosure, the linking member 300A goes from the first position to the second position with a relative movement in translation between the manifold 500A and the linking member 300A. For example, the manifold 500A is pushed towards the linking member 300A, the adapters 200A of which already receive the connectors 600A of the ramp. Each tube 20 received by an adapter 200A passes through one of the joint rings 400A.

Advantageously, the manifold 500A is removably mounted onto the linking member 300A.

In this aspect, the linking member includes a plurality of pairs of adapters, each pair of adapters being linked by an intermediate zone 202A. Advantageously, this intermediate zone 202A allows to come in contact with a cylindrical cell and absorb for example its vibration and reduce the impact on the connection between the tube 20 and the adapter 200A. This intermediate zone can take the shape of a half-cylinder if the cell is cylindrical or the rectangular shape if the cell is prismatic.

In one aspect, the intermediate zone 202A includes means allowing to be fastened to a support and/or act as a support to a clip and/or securing member.

Advantageously, the surface of contact between the linking member 300A and the manifold allows to verify the state of assembly of the manifold case 500A.

More generally, the manifold 500A includes a passage for flow of the fluid 540A communicating with all the connectors 600A. Thus the tubes 20 and the manifold case 100 form a network for circulation of fluid that is part of a thermal management system.

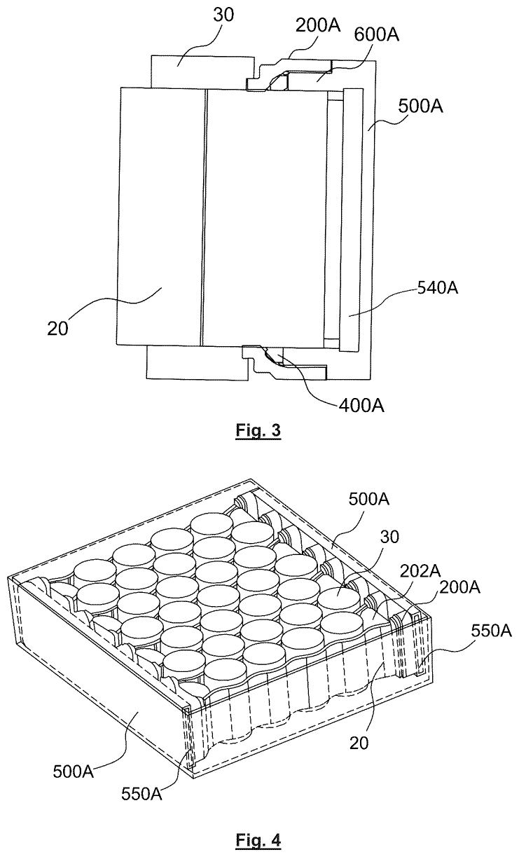

FIG. 3 shows a partial cross-sectional view of a manifold case 100 according to a first aspect of the present disclosure.

It is observed that a connector 600A is received in an adapter 200A with a joint ring 400A sandwiched between the adapter 200A and the connector 600A.

Advantageously, the joint ring 400A is a sealing ring. It allows to ensure the sealing of the connection.

In a preferred aspect, a connector 600A is rigidly connected to a joint ring 400A. It is particularly advantageous, since this allows to place the joint ring 400A in the adapter 200A while keeping its shape.

In a particularly preferred aspect, the connector 600A and the joint ring 400A are overmoulded.

Since the connector 600A communicates with the passage for flow of the fluid 540A, the fluid that circulates in the tube 20 thus enters the flow passage of the manifold 500A.

In the example described, the connector 600A received in the adapter 200A is in the second position.

In an aspect not illustrated, the joint ring 400A is provided with two retaining lips on its inner surface. This allows to obtain better sealing and/or better mechanical gripping with respect to the tube 20.

In one aspect, in the second position, the joint ring compressed and/or deformed between the connector 600A and the adapter 200A interferes with an inner wall of the adapter 200A forming a housing that receives the joint ring.

Advantageously, this allows to reinforce the sealing obtained.

In a preferred aspect (not illustrated), the joint ring 400A does not come in contact with the tube 20 in this first position. Advantageously, this allows to avoid damage to the joint ring 400A by the tube 20 during its insertion.

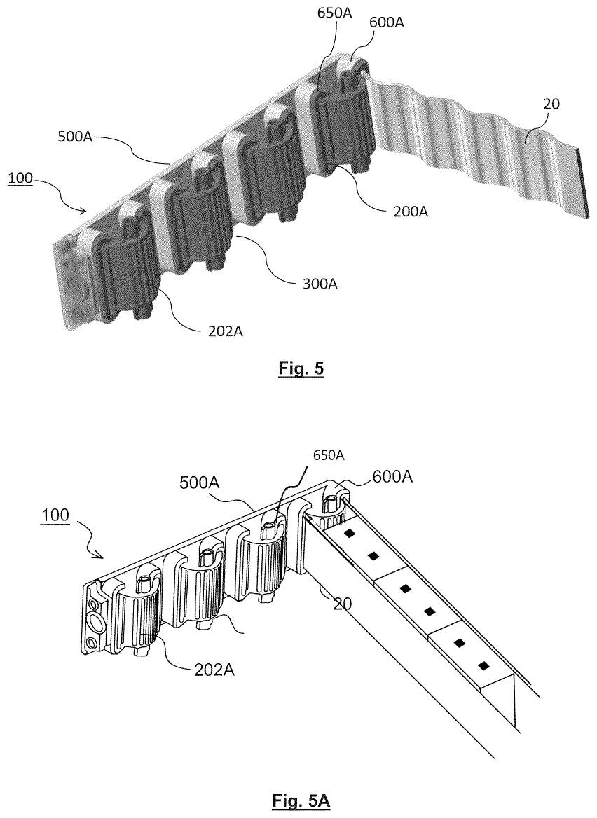

FIG. 4 shows a perspective view of a group of cylindrical cells including a thermal management system of [FIG. 2].

In the example described, the group of cylindrical cells is closed off in a compartment and each connector 600A received in an adapter 200A is in the working position.

FIG. 5 shows a perspective view of a manifold case 100 according to a second aspect of the present disclosure.

According to this second aspect, this manifold case 100 is for example intended to be mounted on a network of pipes for circulation of a fluid of a battery pack.

According to this second aspect, the manifold case 100 according to the present disclosure includes a manifold 500A and a linking member 300A. The manifold 500A comprises a columns 520A provided according to a longitudinal axis with a plurality of connectors 600A spaced apart from each other. The linking member 300A includes adapters 200A. In this example, the connectors 600A are capable of receiving the adapters 200A.

According to the disclosure, each connector 600A defines a passage for flow of the fluid provided with a free end that defines an orifice 650A. Advantageously, an adapter 200A is received in the connector 600A by its orifice 650A.

According to the disclosure, the manifold case 100 comprises a plurality of joint rings 400A to advantageously ensure the sealing. In fact, each joint ring 400A is disposed between a connector 600A and an adapter 200A.

In this first aspect, the adapters 200A each include a passage hole and are capable of receiving tubes by this passage hole so that each tube passes through one of the joint rings 400A, when the adapters 200A are received in the connectors 600A.

The manifold 500A and the linking member 300A cooperate so that the joint rings are sandwiched between the adapters 200A and the connectors 600A. It is recalled here that the ramp is in a second position.

When the connector is in a second position, called working position, the joint rings 400A are capable of being compressed and/or deformed between the manifold 500A and the linking member 300A.

According to the disclosure, the linking member 300A goes from the first position to the second position with a relative movement in translation between the manifold 500A and the linking member 300A. For example, the manifold 500A is pushed towards the linking member 300A, the adapters 200A of which are already received in the connectors 600A of the ramp. Each tube 20 received by an adapter 200A passes through one of the joint rings 400A.

Advantageously, the manifold 500A is removably mounted onto the linking member 300A.

In this aspect, the linking member includes a plurality of pairs of adapters. This will be described in detail below.

More generally, the manifold 500A includes a passage for flow of the fluid 540A communicating with all the connectors 600A. Thus the tubes 20 and the manifold case 100 form a network for circulation of fluid that is part of a thermal management system.

According to a preferred aspect, the tubes 20 are first mounted in the adapters 200A of the collector 300A. Then, the connector 300A is assembled with the manifold 500A.

FIG. 5A shows a perspective view of a manifold case connected to the tubes according to a second aspect. In this example, the tubes are tubes with micro-channels including at least one flat surface that adapts to the prismatic cells.

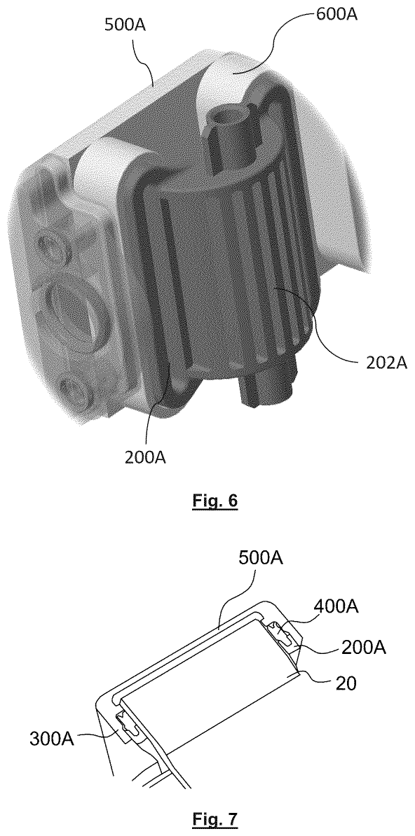

FIG. 6 shows a partial view of a manifold case according to a second aspect of the present disclosure.

Each pair of adapters is linked by an intermediate zone 202A. Advantageously, this intermediate zone 202A allows to come in contact with a cylindrical cell and to absorb for example its vibration and reduce the impact on the connection between the tube 20 and the adapter 200A.

FIG. 7 shows a cross-sectional view of a manifold case 100 according to a second aspect of the present disclosure.

It is observed that an adapter 200A is received in a connector 600A with a joint ring 400A sandwiched between the adapter 200A and the connector 600A.

Advantageously, the joint ring 400A is a sealing ring. It allows to ensure the sealing of the connection.

In a preferred aspect, an adapter 200A is rigidly connected to a joint ring 400A. It is particularly advantageous, since this allows to place the joint ring 400A in the connector 200A while keeping its shape.

In a particularly preferred aspect, the adapter 200A and the joint ring 400A are overmoulded.

In an aspect not illustrated, the joint ring 400A is provided with two retaining lips on its inner surface. This allows to obtain better sealing and/or better mechanical gripping with respect to the tube 20.

In one aspect, in the second position, the joint ring compressed and/or deformed between the connector 600A and the adapter 200A interferes with an inner wall of the connector 600A forming a housing that receives the joint ring.

Advantageously, this allows to reinforce the sealing obtained.

In a preferred aspect (not illustrated), the joint ring 400A does not come in contact with the tube 20 in this first position. Advantageously, this allows to avoid damage to the joint ring 400A by the tube 20 during its insertion.

FIG. 8 shows a partial top view of a manifold case 100 according to a second aspect.

According to the disclosure, the linking member 300A is retained to the manifold 500A in the first position and/or in the second position by mechanical fastening means.

In this second aspect, the mechanical fastening means are a snap-on connection. As illustrated in [FIG. 8], the linking member 300A and the manifold 500A fit together by elastic fitting together. For this purpose, the linking member 300A includes two lugs that cooperate with the back drafts of the manifold 500A.

Advantageously, the fact that the linking member 300A enters its second position gives the operator a sensation of clipping.

Advantageously, the manifold case 100 includes visual verification means allowing to verify the state of assembly between the connector 200A and the manifold column 500A, for example a verification window (not illustrated). For example, various colours can be observed through the verification window.

Another example of the visual verification means is the surface of contact between the linking member 300A and the manifold, which allows to verify the state of assembly of the manifold case 500A.

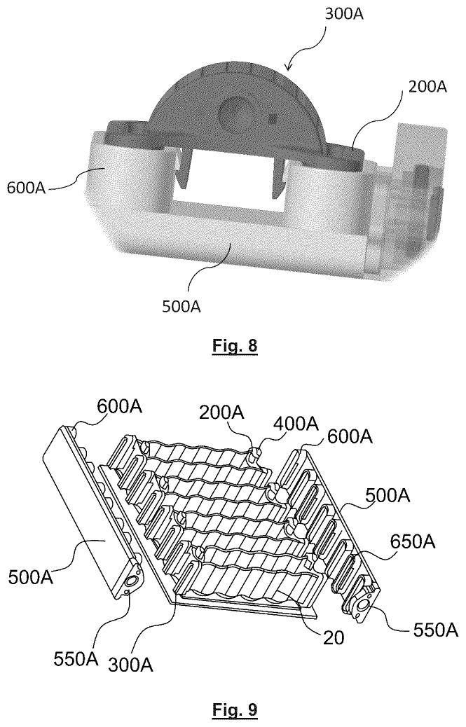

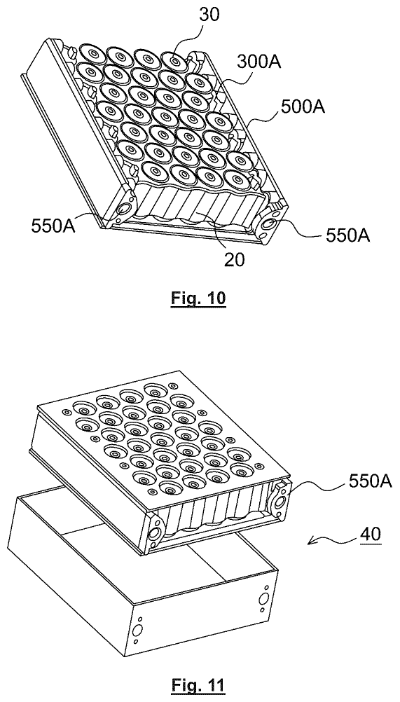

FIG. 9 shows an exploded view of two manifold cases 100, the connectors of which are mounted on the tubes 20 of a thermal management system.

The tubes 20 are arranged according to an interval corresponding to the distance between two adjacent adapters 200A. Each adapter 200A overmoulded with a joint ring 400A is mounted on the two ends of each tube 20.

Then the two manifolds 500A are installed on the two ends of the tubes 20, by pushing the manifolds 500A towards the collectors 300A, the adapters of which are aligned with the connectors 600A, as illustrated in [FIG. 10].

In an advantageous aspect, each manifold 500A includes an orifice 550A acting as an inlet/outlet for fluid in the circulation network.

In the example illustrated, the tubes are tubes with micro-channels including at least one corrugated surface. The cylindrical cells are then mounted in the space separating the tubes 20.

In an aspect illustrated in [FIG. 5A], the tubes are tubes with micro-channels including at least one flat surface to better adapt for example to the flat surfaces to be cooled and/or heated, by those of the prismatic cells.

All of the group of batteries illustrated in [FIG. 10] is then placed in a case provided with two orifices, like in [FIG. 11].

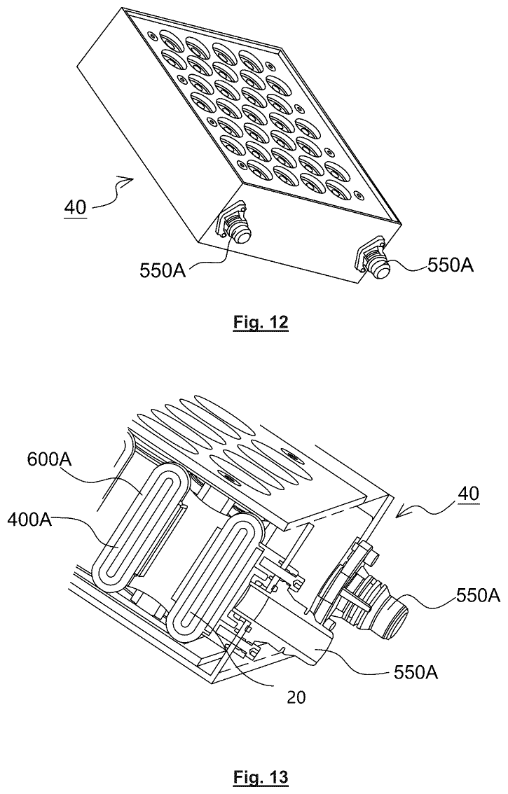

The two orifices 550A act as an inlet/outlet for fluid in the thermal management system, as illustrated by [FIG. 12]. The assembly illustrated forms a battery pack 40 including manifold cases 100 according to the present disclosure.

In [FIG. 13] a partial cross-sectional view according to an axis of the orifice 550A of a group of batteries of [FIG. 12] is observed.

More generally for the present disclosure, the joint ring 400A is advantageously made of an elastomer material in a preferred aspect.

In the compressed state, the joint ring 400A comes in contact with the surface of the tube this allowing to ensure the sealing between the tube and the joint ring. Also advantageously, the joint ring 400A compressed by the adapter 200A and/or the connector 600A ensures mechanical gripping with the tube which is retained in the manifold case despite the pressure of the fluid.

Advantageously, the joint ring 400A is made of suitable material that allows to resist the difference in pressure of the fluid.

In the compressed state, the joint rings sandwiched between the adapters 200A and the connectors 600A ensure the sealing between the tubes 20, the adapters 200A and the connectors 600A.

To assemble a manifold case 100 according to the present disclosure and tubes 20, the following steps can be followed:
a). the linking member 300A having adapters 200A is positioned with respect to the tubes so that each tube 20 is received by one of the adapters 200A and each tube 20 passes through one of the joint rings 400A;
b). a relative movement in translation between the manifold 500A and the linking member 300A is carried out, so that the connectors and the adapters are received by each other and the joint rings 400A are compressed between the manifold 500A and the linking member 300A.

In one aspect, the tubes 20 are prepositioned, for example on a support in the thermal management system.

In one aspect, the linking member 300A is retained to the manifold 500A by mechanical fastening means in step b).

### LIST OF THE REFERENCE SIGNS

TABLE 1

| References | Designations |
|---|---|
| 20 | Tube |
| 30 | Battery |
| 100 | Manifold case |
| 200A | Adapter |
| 202A | Intermediate zone |
| 300A | Linking member |
| 400A | Joint ring |
| 500A | Manifold |
| 520A | Column |
| 540A | Passage for flow of the fluid |
| 550A | Orifice |
| 600A | Connector |
| 650A | Orifice for flow of the fluid |

What is claimed is:

1. Manifold case for a fluid for connecting to tubes, comprising a manifold and a linking member having adapters, the manifold comprising a column provided according to a longitudinal axis with a plurality of connectors spaced apart from each other, each connector defines a passage for flow of the fluid provided with a free end which defines an orifice for flow of the fluid, the connectors and the adapters are capable of being received by each other, and the manifold case comprising a plurality of joint rings, each joint ring is disposed between one of the connectors and one of the adapters,
characterised in that the linking member comprises:
a first position, called assembly position, in which the adapters are capable of receiving tubes so that each tube passes through one of the joint rings the linking member,
a second position, called working position, in which the joint rings are capable of being compressed between the manifold and the linking member,
and in that the linking member goes from the first position to the second position with a relative movement in translation between the manifold and the linking member.

2. Manifold case according to claim 1, wherein in the second position the manifold and the linking member cooperate so that the joint rings are sandwiched between the adapters and the connectors.

3. Manifold case according to claim 1, wherein at least one joint ring is a sealing ring.

4. Manifold case according to claim 1, characterised in that it includes visual verification means allowing to verify the state of assembly between a manifold and a linking member.

5. Manifold case according to claim 1, the linking member is retained to the manifold in the first position and/or in the second position by mechanical fastening means.

6. Manifold case according to claim 1, wherein the linking member is retained to the manifold in the first position and/or in the second position by a snap-on connection.

7. Manifold case according to claim 1, at least one joint ring comprises at least two retaining lips on its inner surface.

8. Manifold case according to claim 1, characterised in that in the working position, a connector and a joint ring, forming a male interface, are received in an adapter that forms a female interface.

9. Manifold case according to claim 8, wherein the connector and the joint ring are overmoulded.

10. Manifold case according to claim 1, wherein, in the working position, an adapter and a joint ring, forming a male interface, are received in a connector that forms a female interface.

11. Manifold case according to claim 10, wherein the adapter and the joint ring are overmoulded.

12. Manifold case according to claim 1, wherein the linking member includes a plurality of pairs of adapters, each pair of adapters being linked by an intermediate zone.

13. Assembly of a manifold case according to claim 1 and at least one tube received in the adapter of the linking member.

14. Thermal management system including at least one manifold case according to claim 1.

15. Battery pack including at least one manifold case according to claim 1.

16. Method for assembling a manifold case according to claim 1 and tubes, including the following steps:
a). the linking member having adapters is positioned with respect to the tubes, so that each tube is received by one of the adapters and each tube passes through one of the joint rings;
b). a relative movement in translation between the manifold and the linking member is carried out, so that the connectors and the adapters are received by each other and the joint rings are compressed between the manifold and the linking member.

17. The method according to claim 16, wherein the tubes are prepositioned.

18. The method according to claim 16, wherein the linking member is retained to the manifold by mechanical fastening means in step b).
